(19) United States
(12) Patent Application Publication
(10) Pub. No.: US 2026/0293854 A1
(43) Pub. Date: Oct. 1, 2026

(54) ANIMAL ASSISTIVE COMMUNICATION SYSTEM

(71) Applicant: Danielle Redd, Trenton, NJ (US)

(72) Inventor: Danielle Redd, Trenton, NJ (US)

(21) Appl. No.: 19/629,886

(22) Filed: Mar. 26, 2026

Related U.S. Application Data
(63) Continuation-in-part of application No. 19/542,321, filed on Feb. 17, 2026.
(60) Provisional application No. 63/778,824, filed on Mar. 27, 2025.

(51) Int. Cl. A01K 29/00; H04M 1/72409

(52) U.S. Cl. CPC A01K 29/00; H04M 1/72409

(57) ABSTRACT

A system may include a plurality of selectable input zones, contact surfaces disposed at the plurality of selectable input zones, and one or more processors programmed to detect contact events independently at each selectable input zone. The one or more processors are programmed to measure a duration of contact events using independent timers associated with each selectable input zone, determine contact events within a first predetermined duration interval as intentional communicative input, determine contact events exceeding a second predetermined duration interval as stabilization behavior, and respond to communicative input at a first selectable input zone during sustained load-bearing contact at a second selectable input zone.

### CROSS-REFERENCE TO RELATED APPLICATIONS

This application is a continuation-in-part of U.S. patent application Ser. No. 19/542,321, filed on Feb. 17, 2026, which claims the benefit of and priority to U.S. Provisional Patent Application No. 63/778,824, filed on Mar. 27, 2025. The entire disclosure of U.S. Provisional Patent Application No. 63/778,824 and Non-Provisional patent application Ser. No. 19/542,321 is incorporated herein by reference in its entirety.

### TECHNICAL FIELD

The present disclosure relates to assistive communication systems for animals, and more particularly to assistive communication systems for animals with biomechanically optimized selectable zones and timing-based behavioral filtering. More specifically, the disclosure relates to mechanically compliant selectable input zones configured for activation by non-human animal appendages and to timing-based behavioral filtering logic configured to distinguish intentional communicative input from stabilization behavior.

### BACKGROUND

Existing animal communication interfaces are commonly adapted from human-oriented pushbuttons, membrane switches, or touchscreen technologies. For example, palm-rejection systems in touchscreen devices suppress undesired contact globally and do not classify stabilization behavior of animals (e.g., climbing, leaning, gripping, perching, etc.). These systems are generally optimized for human-scale activation forces and vertical finger-based contact patterns. Accordingly, there exists a need for an assistive communication system based on forces or patterns that can be reliably generated by animals (e.g., birds).

### SUMMARY

In various embodiments, a system may include a plurality of selectable input zones, a housing comprising recessed openings defining the plurality of selectable input zones, contact surfaces disposed at the plurality of selectable input zones, and one or more processors programmed to detect contact events independently at each selectable input zone. The one or more processors are programmed to measure a duration of contact events using independent timers associated with each selectable input zone, determine contact events within a first predetermined duration interval as intentional communicative input, determine contact events exceeding a second predetermined duration interval as stabilization behavior, and respond to communicative input at a first selectable input zone during sustained load-bearing contact at a second selectable input zone.

In various embodiments, a method for controlling an animal assistive communication system may include mechanically activating one or more selectable input zones using deformable contact surfaces configured for activation by animal appendages. The method may include detecting contact events independently at each of the one or more selectable input zones. The method may include measuring contact duration for each selectable input zone using independent timers. The method may include determining contact events occurring within a first predetermined duration interval as intentional communicative input. The method may include determining contact events exceeding a second predetermined duration interval as stabilization behavior. The method may include detecting communicative input at a first selectable input zone while sustained stabilization contact is maintained at a second selectable input zone without suppressing responsiveness.

### BRIEF DESCRIPTION OF DRAWINGS

These and other aspects and features of the present implementations will become apparent to those ordinarily skilled in the art upon review of the following description of specific implementations in conjunction with the accompanying figures.

FIG. 1 is a block diagram illustrating an example of a computing system according to some embodiments.

FIG. 2 illustrates an example of a top (or front) view and a back (or bottom) view of a cover layer of an animal assistive communication system according to some embodiments.

FIG. 3 illustrates another example of a top (or front) view and a back (or bottom) view of a card holding layer of an animal assistive communication system according to some embodiments.

FIG. 4 illustrates yet another example of a top (or front) view and a back (or bottom) view of a microcontroller layer of an animal assistive communication system according to some embodiments.

FIG. 5 is a diagram illustrating an example animal assistive communication system according to some embodiments.

FIG. 6A and FIG. 6B illustrate an example top perspective view of an animal assistive communication system according to some embodiments.

FIG. 6C illustrates an example plan view of the animal assistive communication system illustrated in FIG. 6A and FIG. 6B.

FIG. 7 is a schematic block diagram illustrating functional interconnection between components of an animal assistive communication system according to some embodiments.

FIG. 8 is a cross-sectional view taken along cross-section A-A of the animal assistive communication system shown in FIG. 6C, according to some embodiments.

FIG. 9 is a front view of a display device presenting a user interface for an animal assistive communication system according to some embodiments.

FIG. 10 is a flowchart illustrating an example methodology for controlling an animal assistive communication system according to some embodiments.

### DETAILED DESCRIPTION

According to certain aspects, embodiments in the present disclosure relate to assistive communication systems for animals, and more particularly to assistive communication systems for animals with biomechanically optimized selectable zones and timing-based behavioral filtering.

In one aspect, existing animal communication interfaces are commonly adapted from human-oriented pushbuttons, membrane switches, or touchscreen technologies. These systems are generally optimized for human-scale activation forces and vertical finger-based contact patterns. When applied to small-bodied animals, such systems: require excessive activation force; remain continuously actuated during stabilization behavior; fail to distinguish communicative input from load-bearing contact; and suppress all contact rather than enabling concurrent interaction. For example, palm-rejection systems in touchscreen devices suppress undesired contact globally and do not classify stabilization behavior while permitting simultaneous communicative input elsewhere. Accordingly, there exists a need for an assistive communication system that: (1) responds to ultra-light contact forces; (2) distinguishes transient communicative contact from sustained stabilization contact; (3) permits concurrent stabilization and communicative interaction; and (4) maintains functionality in moisture-prone environments.

To solve the above-noted problems, according to some embodiments, an animal assistive communication system may include a housing defining recessed selectable input zones configured for activation by non-human animal appendages. The system may further include mechanically compliant contact surfaces (e.g., contact surfaces capable of deflecting, flexing, compressing, or deforming when a force is applied) associated with the selectable input zones, one or more sensors configured to detect deformation or contact, and/or a processor executing timing-based behavioral filtering logic.

In some embodiments, the processor may be configured to distinguish transient communicative contact from sustained stabilization contact while maintaining concurrent responsiveness across selectable input zones. The system thereby enables intentional communicative input while permitting weight-bearing stabilization behavior on the housing. In some embodiments, the system may further include a wireless communication module configured to transmit time-stamped communicative events to a companion software application and an audio output module configured to produce corresponding audio output.

In some embodiments, the system (or device) may include animal assistive communication interface configured for use by birds, particularly small parrots such as cockatiels, that are unable to reliably actuate conventional augmentative and alternative communication (AAC) buttons (e.g., AAC tools developed for humans and dogs). The device may be biomechanically optimized for avian interaction by enabling communication through ultra-light physical contact rather than force-based button presses. The device may employ conductive materials in combination with a programmable microcontroller to detect low-pressure contact generated by a bird's beak or foot and to initiate a corresponding communicative output when a selectable input zone is activated.

In some embodiments, the system (or device) may include a layered mechanical and electrical structure forming a light-touch conductive switching interface. A top medium-density fiberboard (MDF) panel having overall dimensions of approximately 11.504 by 2.252 inches may include seven circular cutouts, each measuring approximately 1.366 by 1.338 inches, that define selectable interaction areas. A bottom MDF panel of the same overall dimensions may include smaller apertures of approximately 0.254 by 0.254 inches configured to permit routing of conductive tape. A thin, flexible balsa wood layer may be positioned between the MDF panels and supports laminated visual communication cards, each card including a conductive backing. A microcontroller, e.g., an Adafruit Circuit Playground Express®, may be mounted on a rear surface of the bottom MDF panel and may be electrically coupled to each selectable input zone by conductive nylon tape routed through the apertures. A final MDF overlay may provide additional rigidity and assists in maintaining positional alignment such that beak or foot pressure is directed over the intended conductive region.

In operation, in some embodiments, the system may allow a bird to contact a laminated visual card positioned above a conductive region by pecking or stepping on the card. The applied pressure may cause the conductive backing of the card to contact underlying conductive tape routed through the aligned cutout, thereby closing an electrical circuit associated with the corresponding input zone. Closure of the circuit may be detected by the microcontroller, which executes stored logic to trigger a preprogrammed audio output corresponding to the activated visual card, the audio being emitted through a connected speaker.

In some embodiments, the system (or device) may include a conductive nylon tape selected for low resistance and minimal activation force; however, the long-term durability of this material has not yet been established. In some embodiments, the system (or device) may include a conductive tape with alternative conductive materials, including conductive sheet materials such as Linqstat®, to improve longevity and sensitivity. In some embodiments, the form factor of the board may be modified by reducing overall dimensions and further lowering pressure activation thresholds to accommodate smaller birds.

In some embodiments, the system (or device) may function as a customizable communication platform for non-vocal or small companion birds, facilitating interaction through symbolic representations, sound association, and structured learning routines. In some embodiments, the system may be configured for a cockatiel. In some embodiments, the touch-sensitive interface may be adaptable for use by other small animals that lack sufficient strength or anatomy to actuate traditional AAC buttons or standard touchscreens. Such animals may include hamsters, guinea pigs, small reptiles, and similar species. The system may provide modularity of the layered structure, adjustability of sensitivity thresholds, and/or flexibility of card layout, enabling adaptations based on species-specific anatomy and behavior. In some embodiments, scaling of device size, modification of housing or enclosure features, and/or species-specific audio pairing can be implemented to support communication and enrichment across a broader range of companion animals.

In some embodiments, the system (or device) may include a communication interface configured for use by small animals, particularly birds, and is further adaptable to any species incapable of exerting the activation force typically required by conventional buttons, keyboards, or capacitive touchscreens. In contrast to existing augmentative and alternative communication (AAC) systems designed for animals possessing sufficient paw strength, beak force, or vocal capability to activate press-based or voice-based tools, the system can enable animal-initiated interaction through ultra-low-force conductive or touch-sensitive inputs.

In some embodiments, the system (or device) may operate on the principle of detecting light physical contact applied by an animal appendage, including a foot, beak, tongue, snout, or similar anatomical feature, wherein the contact completes an electrical circuit or triggers a capacitive or touch-responsive sensing region. An input surface may comprise one or more flat or curved interaction zones arranged as a linear board, circular panel, modular grid, or distributed individual pads. Each interaction zone may incorporate a touch-sensitive mechanism implemented using conductive tape, capacitive sensors, pressure-sensitive film, resistive touch surfaces, flexible printed circuits, or infrared sensors configured to detect proximity or tapping, or combinations thereof. Detection of an input at a given zone may cause a trigger mechanism to activate a corresponding response, which may include playback of an audio file, display of an image, illumination of a visual indicator, generation of tactile feedback, or other perceptible output.

In some embodiments, the system (or device) may include an output subsystem that may comprise one or more speakers, visual displays, vibration motors, or lights, and a control subsystem implemented using a programmable logic device such as an Adafruit Circuit Playground Express®, an Arduino®, a Raspberry Pi®, a custom printed circuit board, or an equivalent controller. The components can be supported within a housing formed from wood, plastic, acrylic, foam, or other chew-resistant, animal-safe materials suitable for the intended species and environment.

In some embodiments, the system (or device) may upload or modify audio content via wired or wireless interfaces including USB, Wi-Fi, Bluetooth, or removable storage media such as an Secure Digital (SD) card. Input sensitivity and activation pressure may be calibrated on a per-animal basis through adjustable firmware parameters. The interface may recognize compound interactions across multiple zones, including combinations such as tap-and-swipe gestures. Visual cues associated with interaction zones may be dynamically altered based on contextual factors such as time of day, location, prior usage patterns, or detected behavior. The system may further include an analytics or data-logging module configured to record interaction frequency, input type, temporal patterns, or other behavioral metrics.

In some embodiments, the system (or device) may enable low-force, animal-initiated communication triggering a corresponding response. The system may include board-based, tile-based, screen-based, or mechanically actuated interfaces, as well as software-driven platforms. The system may operate through physical touch zones, digital touchscreens, or mechanical triggers, regardless of whether interaction is initiated using laminated cards, removable tokens, stickers, embedded images, or dynamically rendered visual displays. Outputs may be delivered as sound, light, visual imagery, or tactile feedback and may be generated from pre-recorded or programmable content, with or without the use of a microcontroller.

In some embodiments, the system (or device) may be configured for use by small animals, including birds, rodents, reptiles, and other species (e.g., species historically excluded from conventional AAC technologies), and provide a scalable and customizable framework for supporting learning, preference expression, and/or two-way communication in a species-appropriate and accessible manner. The system may perform animal recognition, adaptive or context-dependent output logic, learning feedback mechanisms, and/or biologically appropriate vocalizations to enable increasingly intuitive, intelligent, and species-specific communication behavior.

In some embodiments, a communication device for birds may include (1) a microcontroller configured to process input signals, (2) one or more ultra-sensitive touch zones responsive to low-pressure input from a bird's beak or foot, (3) a housing structure made of bird-safe, chew-resistant materials, (4) visual indicators (icons, images, or words) aligned with each touch zone, and/or (5) a speaker or audio module configured to play audio corresponding to each activated zone.

In some embodiments, the microcontroller may be a microcontroller board such as a Circuit Playground Express® or compatible model. The touch zones may be capacitive or resistive sensors calibrated for low-weight activation.

In some embodiments, the device may further include mounting features for attachment to a birdcage or flat surface. The audio output may be user-configurable with custom recorded sounds. The touch zones may be created or formed using conductive tape or conductive sheet materials adhered within the housing. The microcontroller may be programmed with logic to detect low-pressure activation and play associated audio.

In some embodiments, the audio may be recordable through an onboard microphone and recording interface. Audio files may be uploaded via a desktop or web-based interface. Each touch zone is paired with a removable visual card held in place above the touch surface.

In some embodiments, the device may be adapted for use by other small animals with limited pressure strength, including hamsters, small reptiles, and/or other companion pets. The housing may include layered construction with a flexible intermediate layer that enables circuit completion through light touch.

In some embodiments, a communication system for small animals may include one or more ultra-sensitive input zones that activate an associated response via physical interaction requiring minimal force, including but not limited to beak, tongue, foot, or snout interaction, implemented through physical touch zones or digital touchscreens using capacitive, resistive, or proximity-based technologies.

In some embodiments, the input zones may be arranged in a fixed board, modular tiles, or distributed components. Each input may be paired with a visual identifier (e.g., icon, image, light-emitting diode (LED), label) representing the associated sound or command.

In some embodiments, input sensitivity can be achieved through conductive or capacitive technology, including but not limited to: conductive tape, capacitive wire mesh, piezo film, or light-based sensors. In some embodiments, the response triggered by input can be customizable via user interface, app, or web-based portal, allowing the user to assign audio, visual, or tactile feedback.

In some embodiments, the device may be configured to recognize individual users (animals) through input patterns, Radio-Frequency Identification (RFID) tags, or other recognition systems.

In some embodiments, the housing may be layered. The housing may include (1) a top cover for protecting internal elements, (2) a middle layer containing laminated communication indicators (e.g., laminated cards, embedded images, removable tokens, or stickers), and/or (3) a base layer housing all electronic and conductive components.

In some embodiments, the device can be used as a learning tool to support communication, decision-making, preference expression, or environmental enrichment.

In some embodiments, a method of training a small animal to use a communication interface may be provided by associating specific sensory feedback with corresponding physical input, enabling two-way interaction.

In some embodiments, the input and output interface is implemented via a capacitive or resistive touchscreen (tablet or embedded display), pre-programmed to respond to ultra-light input through visual icon tapping. In some embodiments, interaction data (e.g., zone activation, frequency, sequence) may be captured and/or stored using onboard memory of transmitted to a connection application for the purpose of logging, analysis, behavior tracking, or user feedback.

In some embodiments, visual or auditory feedback is delivered through a digital display, LED matrix, or screen-based output device to reinforce communication learning. In some embodiments, the touch-sensitive interface is dynamically programmable, allowing different zones, commands, or visual indicators to be redefined in real time through an app or software platform.

In some embodiments, the logic controller may be an open-source microcontroller, such as the Adafruit Circuit Playground Express®, Arduino or Raspberry Pi®, programmed to detect ultra-light input and trigger user-defined output.

In some embodiments, activation may occur through a purely mechanical or analog mechanism without programmable logic, provided the interaction method relies on low-force input for animal communication.

In some embodiments, audio outputs may be selected or programmed to represent multiple languages, tones, or animal-specific vocalizations. In some embodiments, the interface can support multiple animals interacting with the system independently or sequentially, optionally recognizing individual users through behavior, pattern, or RFID recognition.

In some embodiments, output varies based on prior animal interaction, usage frequency, accuracy, or time-based patterns—allowing adaptive learning or feedback-based modification.

In some embodiments, an animal assistive communication system may include a housing, mechanically compliant contact surfaces, non-illuminated static identifiers, one or more sensors, and/or one or more processors. The housing may be configured to structurally support the weight of a small-bodied animal and may comprise recessed openings defining a plurality of selectable input zones. The mechanically compliant contact surfaces may be disposed at the selectable input zones and configured for activation by non-human animal appendages. The non-illuminated static identifiers may be associated with the selectable input zones. The one or more sensors may be associated with the selectable input zones and configured to generate electrical signals in response to deformation or contact of the mechanically compliant contact surfaces by an animal appendage. The one or more processors may be programmed to execute timing-based behavioral filtering logic. Electronic components may be disposed beneath the selectable input zones and physically separated from the selectable input zones by at least one structural barrier configured to reduce exposure to moisture, saliva, or debris.

In some embodiments, each selectable input zone may be configured to respond to localized contact forces characteristic of small-bodied animal appendages, and/or permit deformation under transient contact while maintaining structural integrity under sustained load-bearing contact.

In some embodiments, the one or more processors may be programmed to: detect contact events independently at each selectable input zone; measure duration of contact events using independent timers associated with each selectable input zone; classify contact events within a first predetermined duration interval as intentional communicative input; classify contact events exceeding a second predetermined duration interval as stabilization behavior; and/or maintain responsiveness to communicative input at a first selectable input zone during sustained load-bearing contact at a second selectable input zone. Examples of intentional communicative input include a quick peck or tap on a zone. These are short and deliberate interactions, and are different than the animal resting or leaning on the device. Examples of stabilization behavior include an animal standing, perching, leaning, gripping, or resting on a surface for balance or support. In these cases, the contact is sustained and not intended to trigger a response. For example, a bird may perch or lean on the device while maintaining balance.

In some embodiments, the second predetermined duration interval may be longer than the first predetermined duration interval, such that shorter contact is treated as intentional input, while longer contact is treated as stabilization. For example, the first predetermined duration interval may be in a range of about 300 ms to about 500 ms, and the second predetermined duration interval may be in a range of about 1 second to about 2 seconds.

In some embodiments, the processor may maintain separate state machines for each selectable input zone such that sustained contact at a second selectable input zone classified as stabilization behavior does not suppress signal detection or classification at a first selectable input zone. In some embodiments, the mechanically compliant contact surfaces may include a layered structure including at least one deformable layer positioned above the one or more sensors.

In some embodiments, the selectable input zones may include surface geometries and material compliance configured to accommodate non-vertical contact angles and localized contact areas characteristic of animal appendages. Activation of a selectable input zone may be triggered by transient deformation of the mechanically compliant contact surface distinct from sustained load-bearing stabilization contact.

In some embodiments, the processor may maintain independent timers for each selectable input zone. In some embodiments, the one or more sensors may include one or more of capacitive sensors, force-sensitive resistors, thin-film pressure sensors, piezoelectric sensors, membrane switches, or combinations thereof. In some embodiments, sensitivity thresholds and timing intervals may be configurable based on anatomical characteristics of a target animal species.

In some embodiments, the system may include a wireless communication module configured to transmit time-stamped communicative events to a mobile software application.

In some embodiments, the housing may be configured to support stabilization behavior including climbing, gripping, leaning, or perching while remaining responsive to communicative input. In some embodiments, the non-illuminated static identifiers comprise printed cards, engraved symbols, tactile textures, or passive displays configured to avoid flicker detectable relative to a critical flicker fusion threshold of a target animal species.

In some embodiments, a method for operating an animal assistive communication system, may include mechanically enabling low-force activation at selectable input zones using deformable contact surfaces configured for animal appendages. The method may include detecting contact events independently at each selectable input zone. The method may include measuring contact duration for each selectable input zone using independent timers. The method may include classifying contact events occurring within a first predetermined duration interval as intentional communicative input. The method may include classifying contact events exceeding a second predetermined duration interval as stabilization behavior. The method may include permitting detection of communicative input at a first selectable input zone while sustained stabilization contact is maintained at a second selectable input zone without suppressing responsiveness.

In some embodiments, detecting contact events may be performed using one or more of capacitive sensors, force-sensitive resistors, thin-film pressure sensors, piezoelectric sensors, membrane switches, or combinations thereof.

In some embodiments, the first and second predetermined duration intervals may be configurable based on anatomical characteristics of a target animal species. The mechanically compliant contact surfaces may be configured to require an activation force below that required for human-oriented input devices.

In some embodiments, each selectable input zone requires an activation force less than 50 grams. In some embodiments, each selectable input zone permits surface deformation within a range of 1-3 mm. In some embodiments, the one or more sensors may be configured to detect contact through a non-conductive, deformable protective overlay positioned to reduce exposure to moisture, saliva, and particulate contamination while permitting detection of contact forces within a range of 10-50 grams.

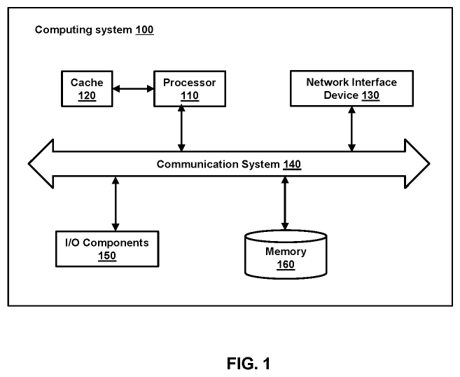

Referring to FIGS. 1-9, embodiments of systems and methods for assistive communication systems for animals with biomechanically optimized and/or mechanically compliant selectable input zones configured for activation by non-human animal appendages, and/or timing-based behavioral filtering logic configured to distinguish intentional communicative input from stabilization behavior.

FIG. 1 is a block diagram illustrating an example of a computing system according to some embodiments. Referring to FIG. 1, the illustrated example computing system 100 includes one or more processors 110 in communication, via a communication system 140 (e.g., bus), with memory 160, at least one network interface controller 130 with network interface port for connection to a network (not shown), and other components, e.g., an input/output (“I/O”) components interface 150 connecting to a display (not illustrated) and an input device (not illustrated). Generally, the processor(s) 110 will execute instructions (or computer programs) received from memory. The processor(s) 110 illustrated incorporate, or are directly connected to, cache memory 120. In some instances, instructions are read from memory 160 into the cache memory 120 and executed by the processor(s) 110 from the cache memory 120.

In more detail, the processor(s) 110 may be any logic circuitry that processes instructions, e.g., instructions fetched from the memory 160 or cache 120. In some implementations, the processor(s) 110 are microprocessor units or special purpose processors. The computing device 100 may be based on any processor, or set of processors, capable of operating as described herein. The processor(s) 110 may be single core or multi-core processor(s). The processor(s) 110 may be multiple distinct processors.

The memory 160 may be any device suitable for storing computer readable data. The memory 160 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 100 may have any number of memory devices as the memory 160.

The cache memory 120 is generally a form of computer memory placed in close proximity to the processor(s) 110 for fast read times. In some implementations, the cache memory 120 is part of, or on the same chip as, the processor(s) 110. In some implementations, there are multiple levels of cache 120, e.g., L2 and L3 cache layers.

The network interface controller 130 manages data exchanges via the network interface (sometimes referred to as network interface ports). The network interface controller 130 handles the physical and data link layers of the OSI model for network communication. In some implementations, some of the network interface controller's tasks are handled by one or more of the processor(s) 110. In some implementations, the network interface controller 130 is part of a processor 110. In some implementations, a computing system 100 has multiple network interfaces controlled by a single controller 130. In some implementations, a computing system 100 has multiple network interface controllers 130. In some implementations, each network interface is a connection point for a physical network link (e.g., a cat-5 Ethernet link). In some implementations, the network interface controller 130 supports wireless network connections and an interface port is a wireless (e.g., radio) receiver/transmitter (e.g., for any of the IEEE 802.11 protocols, near field communication “NFC”, Bluetooth, ANT, or any other wireless protocol). In some implementations, the network interface controller 130 implements one or more network protocols such as Ethernet. Generally, a computing device 100 exchanges data with other computing devices via physical or wireless links through a network interface. The network interface may link directly to another device or to another device via an intermediary device, e.g., a network device such as a hub, a bridge, a switch, or a router, connecting the computing device 100 to a data network such as the Internet.

The computing system 100 may include, or provide interfaces for, one or more input or output (“I/O”) devices 150. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

Other components may include an I/O interface, external serial device ports, and any additional co-processors. For example, a computing system 100 may include an interface (e.g., a universal serial bus (USB) interface) for connecting input devices, output devices, or additional memory devices (e.g., portable flash drive or external media drive). In some implementations, a computing device 100 includes an additional device such as a co-processor, e.g., a math co-processor can assist the processor 110 with high precision or complex calculations.

In some embodiments, an animal assistive communication system may include at least one or more components of a computing system 100. In some embodiments, an animal assistive communication system may include one or more computing systems 100.

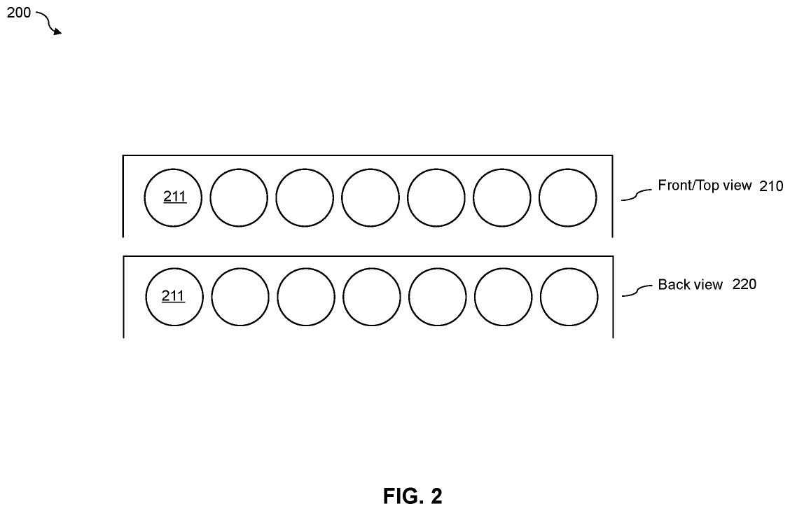

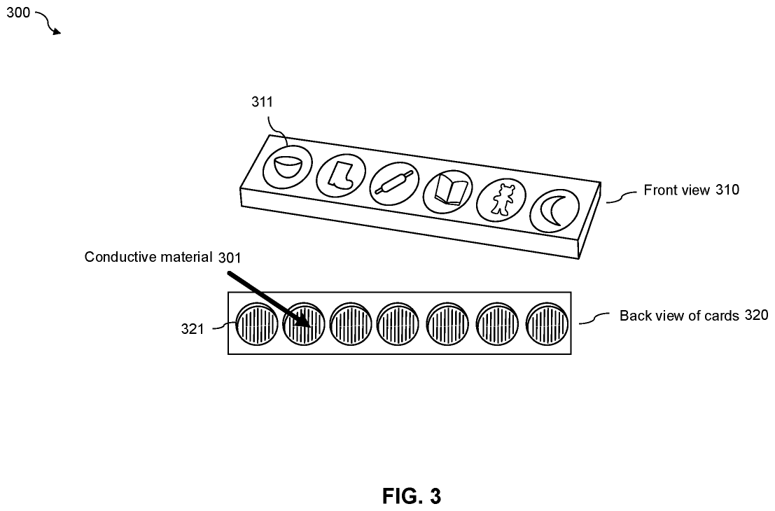

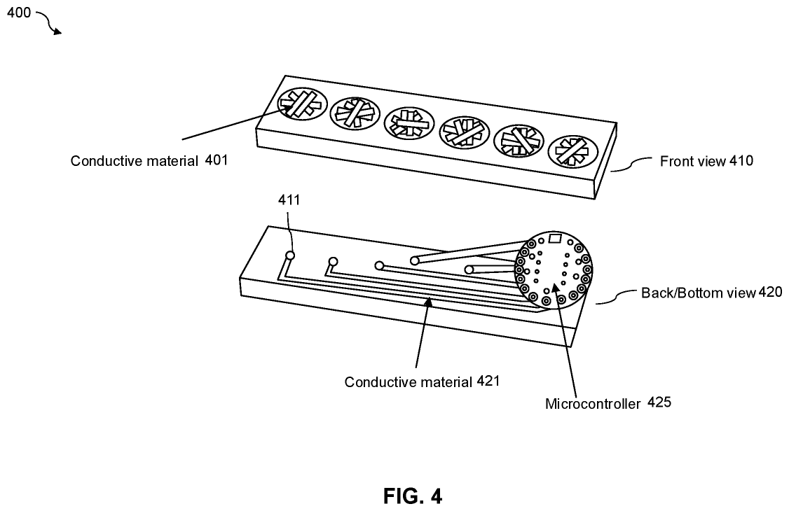

In some embodiments, an animal assistive communication system (e.g., an animal assistive communication device) may include a plurality of layers of circuitry and/or interaction zones. Each layer can serve a distinct function in enabling low-force avian communication through touch-sensitive zones. For example, an animal assistive device may include a top cover layer (as shown in FIG. 2), a card holding layer (shown in FIG. 3), and/or a microcontroller layer (shown in FIG. 4).

FIG. 2 is a diagram 200 illustrating an example cover layer of an animal assistive communication system. FIG. 2 illustrates an example of a top (or front) view 210 and a back (or bottom) view 220 of the cover layer. In some embodiments, the cover layer may include an uppermost panel made of Medium-Density Fiberboard (MDF) or similar rigid material. The cover layer may contain circular cutouts 211 that align with the touch zones beneath. The cover layer may act as a cover, ensuring the bird interacts only with the designated button areas. The top (or front) view 210 illustrates the cover layer as the uppermost layer, underneath which the cards (e.g., visual communication cards 311) sit or are positioned.

FIG. 3 is a diagram 300 illustrating an example card holding layer of an animal assistive communication system. FIG. 3 illustrates an example of a top (or front) view 310 and a back (or bottom) view 320 of the card holding layer. In some embodiments, the card holding layer may be positioned directly beneath the top cover. The card holding layer may hold laminated visual communication cards 311. Each card may have a conductive backing 321 that faces downward. In some embodiments, the conductive backing 321 may include a conductive material 301. When pressure is applied (by a beak or foot), the conductive backing may make contact through the cutouts 211 shown in FIG. 2, bridging the touch-sensitive points in the circuitry below.

FIG. 4 is a diagram 400 illustrating an example microcontroller layer (or base layer) of an animal assistive communication system. FIG. 4 illustrates an example of a top (or front) view 410 and a back (or bottom) view 420 of the microcontroller layer. In some embodiments, the microcontroller layer may be the foundation of an animal assistive communication device, containing embedded circuitry and/or one or more microcontrollers 425 (e.g., an all-in-one, circular microcontroller board such as Adafruit Circuit Playground Express®). In some embodiments, the one or more microcontrollers may include one or more processors. In some embodiments, conductive tape 421 (which may include a conductive material) may be routed from the controller 425 to multiple circular connection points 401 directly above small holes 411 in the microcontroller layer. In some embodiments, when the circuit is closed via a press, the corresponding audio cue may be triggered.

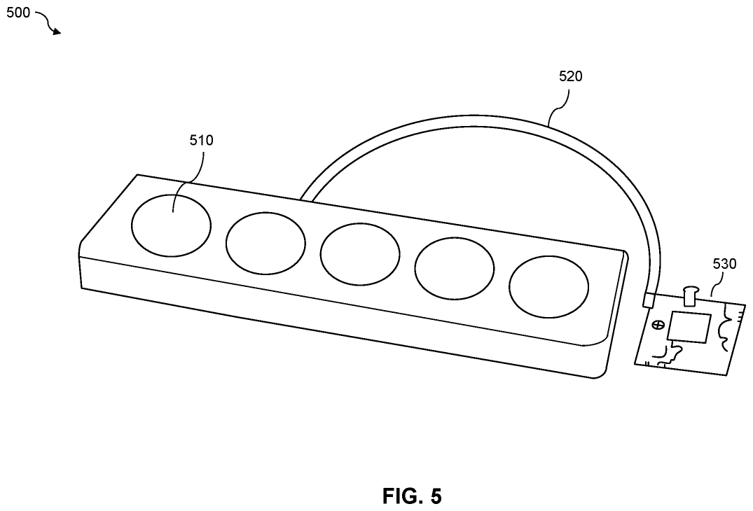

FIG. 5 illustrates an example animal assistive communication system 500 including interaction zones 510, conductive routes, tape, or cable 520, and/or circuitry or microcontroller 530. The three layers (e.g., cover layer, card holding layer, microcontroller layer) can function as a unified system, allowing small animals to trigger audio responses through gentle, instinctive interactions.

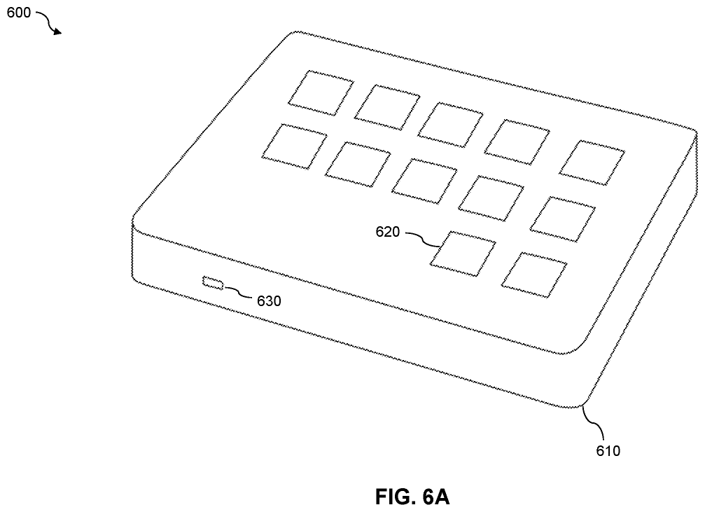

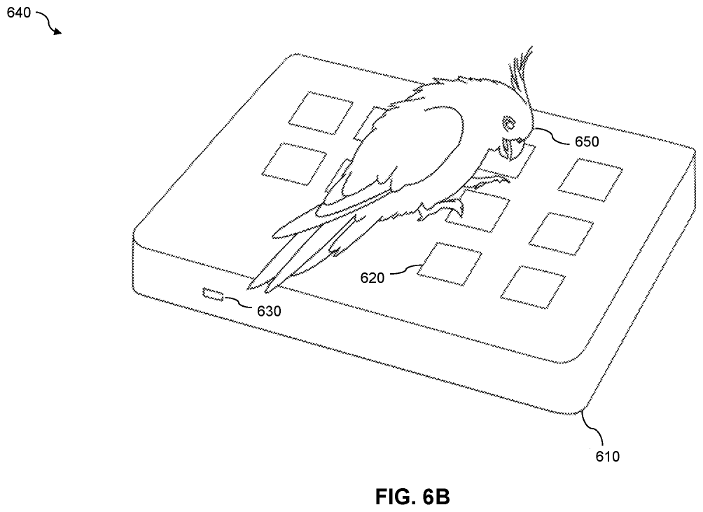

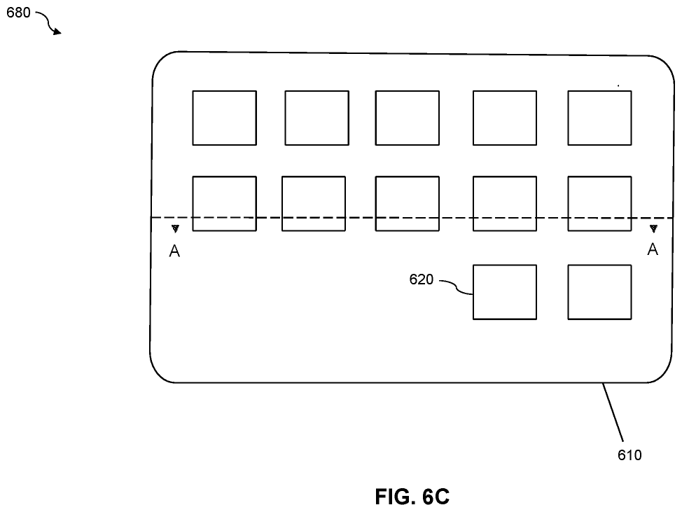

FIG. 6A is a top perspective view 600 illustrating housing 610, recessed selectable input zones 620, and/or optional structural element 630. FIG. 6B is a perspective view 640 of an animal 650 interacting with a zone 620 while stabilized by housing 610, with optional structural element 630. FIG. 6C is a top plan view 680 illustrating spatial arrangement of selectable input zones 620 within housing 610.

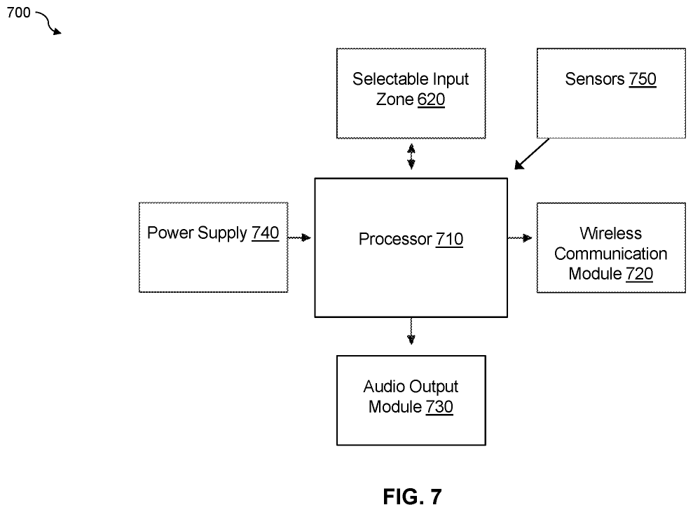

FIG. 7 is a schematic block diagram 700 illustrating functional interconnection between selectable input zones 620, processor 710, wireless communication module 720, audio output module 730, power supply 740, and/or one or more sensors 750.

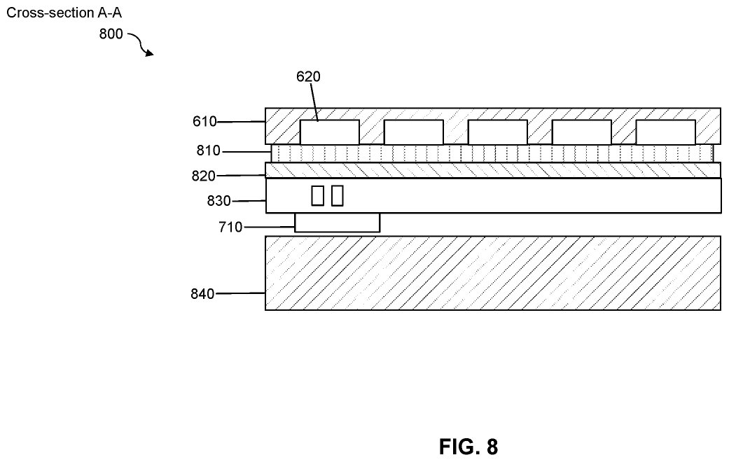

FIG. 8 is a cross-sectional view 800 taken along cross-section A-A shown in FIG. 6C. The cross-sectional view 800 illustrates the layered relationship of housing 610, protective overlay 810, selectable input zones 620, volume-conductive film 820, circuit substrate 830, processor 710, and/or base 840.

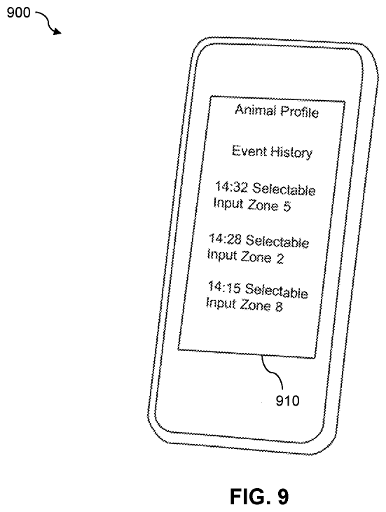

FIG. 9 is a front view of a display device 900 presenting a user interface 910 of a companion software application configured to receive and record time-stamped events transmitted by wireless communication module 720. In some embodiments, the display device 900 may include at least one or more components of a computing system 100. In some embodiments, the display device 900 may include one or more computing systems 100.

Referring to FIG. 1 to FIG. 9, housing 610 may define a plurality of recessed openings forming selectable input zones 620. As illustrated in FIG. 6A and FIG. 6B, the selectable input zones 620 may be arranged to facilitate interaction by a small-bodied animal. Each selectable input zone 620 may include a vertical well configured to receive a mechanically compliant contact assembly.

In some embodiments, the contact assembly disposed within each selectable input zone 620 may include a multi-layered stack (as shown in the cross-section 800 of FIG. 8). The multi-layered stack may include a protective overlay 810 positioned within the recessed opening of housing 610 and configured to receive direct contact from an animal appendage; a volume-conductive, pressure-sensitive film 820 disposed beneath protective overlay 810; and/or a circuit substrate 830 including at least one conductive electrode gap vertically aligned with the selectable input zone 620.

In some embodiments, the protective overlay 810 may include a semi-rigid laminated identifier substrate configured to function as a vertically compliant element within the recessed well of housing 610. In some embodiments, a clearance gap may be provided between lateral edges of protective overlay 810 and sidewalls of the recessed opening to permit vertical compliance while limiting lateral displacement.

In some embodiments, localized pressure from an animal appendage may be transmitted through protective overlay 810 to volume-conductive film 820, causing deformation sufficient to electrically bridge the electrode gap of circuit substrate 830. Protective overlay 810 may form at least a portion of the mechanically compliant contact surface. In some embodiments, protective overlay 810 may be electrically non-conductive.

In some embodiments, protective overlay 810 may comprise laminated polymer films, polyester, polyethylene terephthalate (PET), silicone elastomers, thermoplastic polyurethane (TPU), polyvinyl chloride (PVC), or other deformable materials suitable for moisture-prone environments. In some embodiments, volume-conductive film 820 may comprise a carbon-loaded polyethylene film or other pressure-sensitive polymer material configured to exhibit a reduction in electrical resistance under localized compressive force sufficient to bridge the conductive electrode gap of circuit substrate 830.

In some embodiments, circuit substrate 830 may comprise a printed circuit board (PCB) positioned beneath selectable input zones 620 and may be secured to base 840 using mechanical fasteners, standoffs, adhesive bonding, or similar mounting structures. Electronic components, including one or more processors 710, may be disposed on a lower surface of circuit substrate 830 such that the fiberglass body and upper copper surface of circuit substrate 830 form a structural barrier separating selectable input zones 620 from sensitive electronic components.

In some embodiments, overlay thickness (e.g., thickness of protective overlay 810) may range from approximately 0.05 mm to 3.0 mm. In some embodiments, the contact assembly may be configured to: deform under contact forces of approximately 10-50 grams; permit surface deformation of approximately 1-3 mm; elastically recover following deformation; and resist degradation in moisture-prone environments. In some embodiments, base 840 may cooperate with housing 610 to form a protective enclosure for internal electronics. Optional structural element 630 may comprise a power port, data connector, cable guide, service access opening, or similar feature.

In some embodiments, selectable input zones 620 may be configured for activation by light contact forces characteristic of small-bodied animal appendages. In some embodiments, selectable input zones 620 may be optimized for cockatiel-sized birds: the activation force may be approximately 10-50 grams and the surface deformation travel may be approximately 1-3 mm. The structure can permit localized deformation under transient contact while maintaining structural integrity under sustained load-bearing stabilization. Surface geometry may accommodate non-vertical contact angles.

In some embodiments, activation force and deformation travel may be adjusted according to anatomical characteristics, body mass, and/or appendage force of a target species. As used herein, the term “mechanically compliant” refers to contact surfaces configured to deform under species-appropriate localized contact forces sufficient to produce an electrical response while maintaining structural integrity under sustained load-bearing stabilization.

In some embodiments, one or more processors 710 may include a programmable microcontroller unit (MCU), such as an ESP32® dual-core processor, an ARM Cortex-M® series controller, or other programmable control device configured to execute firmware implementing the timing-based behavioral filtering logic described herein. The processor 710 may be configured to maintain independent software timers and state machines for each selectable input zone 620, and may utilize hardware interrupts, polling cycles, or hybrid monitoring techniques to detect sensor state changes in real time.

In some embodiments, selectable input zones 620 may be electrically coupled to processor 710 via one or more input channels, including analog-to-digital converter (ADC) inputs, general-purpose input/output (GPIO) pins, capacitive sensing channels, or combinations thereof. Each selectable input zone 620 may generate an electrical signal corresponding to deformation or contact of its associated mechanically compliant contact surface.

In some embodiments, one or more sensors 750 associated with selectable input zones 620 may comprise: capacitive sensors configured to detect touch through protective overlay 810; force-sensitive resistors or volume-conductive films 820 configured to detect localized pressure; thin-film pressure sensors; piezoelectric sensing elements; membrane switches; or hybrid sensing architectures. In some embodiments, selectable input zones 620 may include the one or more sensors. In some embodiments, the one or more sensors may be separate from selectable input zones 620. Processor 710 may receive sensor signals from selectable input zones 620 and executes the timing-based behavioral filtering logic to classify contact events.

In some embodiments, audio output module 730 may comprise a speaker, piezoelectric transducer, digital-to-analog audio interface, or I2S (inter-IC sound)-based audio amplifier configured to produce pre-recorded or synthesized audio corresponding to an activated selectable input zone 620. Wireless communication module 720 may comprise a Bluetooth Low Energy (BLE) transceiver, Wi-Fi module, or other radio frequency communication interface configured to transmit time-stamped event data to an external computing device 900. Power supply 740 may comprise a rechargeable lithium-polymer battery, replaceable batteries, regulated DC input, or other suitable power source configured to provide operating power to processor 710 and associated electronic components.

In some embodiments, in operation, selectable input zones 620 may provide sensor signals to processor 710. Processor 710 may process the sensor signals and selectively generates control signals to audio output module 730 and wireless communication module 720 based on classification of contact events. Power supply 740 may provide electrical energy to the processor 710 and associated electronic components.

In some embodiments, one or more processors 710 may be configured to detect contact events independently at each selectable input zone; measure contact duration using independent timers; and/or maintain independent state machines per zone. In some embodiments, upon detection of a sensor signal exceeding a baseline or threshold, a timer associated with that selectable input zone may be initiated. If the sensor signal drops below threshold before a first predetermined duration interval, the event may be classified as intentional communicative input. If the sensor signal remains above threshold beyond a second predetermined duration interval, the event may be classified as stabilization behavior. In some embodiments, contact events classified as stabilization behavior do not trigger communicative output, such as audio playback. Stabilization classification at one zone does not suppress detection or classification at another zone. The logic may operate independently of sensing modality.

In some embodiments, the first predetermined duration interval may be less than approximately 300-500 milliseconds. The second predetermined duration interval may be greater than approximately 1-2 seconds. Thresholds may be configurable based on anatomical characteristics of a target species.

In some embodiments, a small-bodied animal may utilize housing 610 for climbing, leaning, gripping, or perching while engaging a selectable input zone. As used herein, the term “small-bodied animal” refers to a non-human animal of a size insufficient to reliably actuate input devices optimized for human finger-based activation forces, including but not limited to birds, small mammals, reptiles, and similar species. Concurrent communicative input is maintained during stabilization contact. Referring to FIG. 6B, animal 650 represents a small-bodied animal interacting with the system.

In some embodiments, wireless communication module 720 transmits time-stamped communicative events to device 900 (see FIG. 9). User interface 910 may display: event history including time-stamped communicative activations; identification of the activated selectable input zone corresponding to each event; animal profile information; and/or configuration settings.

In some embodiments, an animal assistive communication system may include non-illuminated static identifiers that may include printed cards, engraved symbols, tactile textures, or passive display elements. Such non-illuminated identifiers may rely on reflected ambient light rather than electronically refreshed illumination, thereby avoiding refresh-rate flicker associated with active displays.

In some embodiments, an animal assistive communication system may perform sensing by performing capacitive detection through protective overlay 810. In some embodiments, sensing may include pressure-responsive detection through deformation of compliant contact surfaces. The animal assistive communication system may include timing-based behavioral filtering logic. The timing-based behavioral filtering logic may be configured to operate with capacitive, resistive, pressure-based, or hybrid architectures.

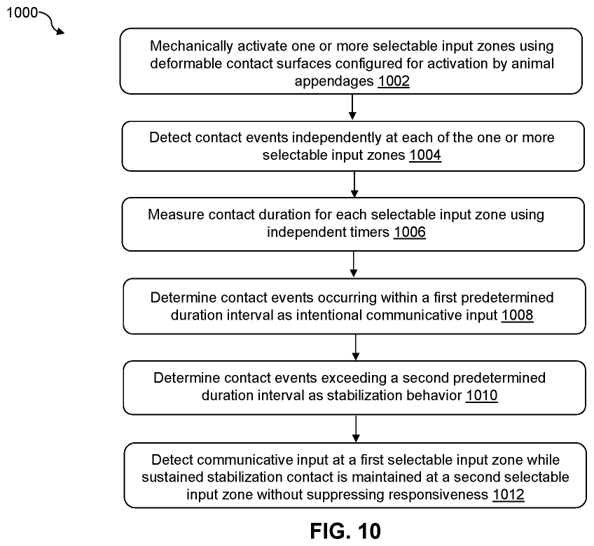

FIG. 10 is a flowchart illustrating an example methodology/process 1000 for controlling an animal assistive communication system according to some embodiments. In some implementations, the process 1000 is performed by one or more processors (e.g., one or more processors 110, one or more processors 710), or a device/apparatus (e.g., animal assistive communication devices shown in FIGS. 2-8, or a mobile device 900). In some embodiments, the process 1000 is performed by other entities. In some embodiments, the process 1000 includes more, fewer, or different steps than shown in FIG. 10. In some embodiments, the animal assistive communication system (e.g., animal assistive communication devices shown in FIGS. 2-8) may include a plurality of selectable input zones (e.g., input zones 620, interaction zones 510); a housing (e.g., housing 610) comprising recessed openings (e.g., opening or cutout 211) defining the plurality of selectable input zones; contact surfaces (e.g., visual communication cards 311, conductive material 401) disposed at the plurality of selectable input zones and configured for activation by animal appendages (e.g., beak of a bird 650); one or more sensors (e.g., sensors 750) associated with the plurality of selectable input zones and configured to generate electrical signals in response to deformation or contact of the contact surfaces by an animal appendage; and one or more processors (e.g., one or more processors 110, one or more processors 710).

In this example methodology, a process 1000 begins at step 1002 by mechanically activating one or more selectable input zones using deformable contact surfaces configured for activation by animal appendages. In some embodiments, the deformable contact surfaces may be mechanically compliant contact surfaces that are activated by an activation force smaller than an activation force required to activate human-oriented input devices.

At step 1004, the one or more processors may detect contact events independently at each of the one or more selectable input zones. In detecting contact events, the one or more processors may detect the contact events using one or more of capacitive sensors, force-sensitive resistors, thin-film pressure sensors, piezoelectric sensors, membrane switches, or combinations thereof.

At step 1006, the one or more processors may measure contact duration for each selectable input zone using independent timers.

At step 1008, the one or more processors may determine contact events occurring within a first predetermined duration interval as intentional communicative input.

At step 1010, the one or more processors may determine contact events exceeding a second predetermined duration interval as stabilization behavior. In some embodiments, the first and second predetermined duration intervals are configurable based on anatomical characteristics of a target animal species.

At step 1012, the one or more processors may detect communicative input at a first selectable input zone while sustained stabilization contact is maintained at a second selectable input zone without suppressing responsiveness.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the blocks of various examples must be performed in the order presented. As will be appreciated by one of skill in the art the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In some examples, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed:

1. A system comprising:
a plurality of selectable input zones;
contact surfaces disposed at the plurality of selectable input zones and configured for activation by animal appendages;
one or more sensors associated with the plurality of selectable input zones and configured to generate electrical signals in response to deformation or contact of the contact surfaces by an animal appendage; and
one or more processors programmed to:
detect contact events independently at each selectable input zone;
measure a duration of contact events using independent timers associated with each selectable input zone;
determine contact events within a first predetermined duration interval as intentional communicative input;
determine contact events exceeding a second predetermined duration interval as stabilization behavior; and
respond to communicative input at a first selectable input zone during sustained load-bearing contact at a second selectable input zone.

2. The system of claim 1, further comprising:
electronic components disposed beneath the selectable input zones and physically separated from the selectable input zones by at least one structural barrier configured to reduce exposure to moisture, saliva, or debris.

3. The system of claim 1, wherein each selectable input zone is configured to:
in response to localized contact forces characteristic of small-bodied animal appendages, permit deformation under transient contact while maintaining structural integrity under sustained load-bearing contact.

4. The system of claim 1, wherein the one or more processors are configured to maintain separate state machines for each selectable input zone such that sustained contact at a second selectable input zone determined as stabilization behavior does not suppress signal detection or classification at a first selectable input zone.

5. The system of claim 1, wherein
the contact surfaces are mechanically compliant contact surfaces, and
the mechanically compliant contact surfaces comprise a layered structure including at least one deformable layer positioned above the one or more sensors.

6. The system of claim 1, wherein the selectable input zones configure surface geometries and material compliance to accommodate non-vertical contact angles and localized contact areas characteristic of animal appendages.

7. The system of claim 1, wherein activation of a selectable input zone is triggered by transient deformation of the mechanically compliant contact surface distinct from sustained load-bearing stabilization contact.

8. The system of claim 1, wherein the one or more processors are configured to maintain independent timers for each selectable input zone.

9. The system of claim 1, wherein the one or more sensors comprise one or more of capacitive sensors, force-sensitive resistors, thin-film pressure sensors, piezoelectric sensors, membrane switches, or combinations thereof.

10. The system of claim 1, wherein the one or more processors are programmed to execute timing-based behavioral filtering logic such that sensitivity thresholds and timing intervals are configurable based on anatomical characteristics of a target animal species.

11. The system of claim 1, further comprising a wireless communication module configured to transmit time-stamped communicative events to a mobile software application.

12. The system of claim 1, further comprising:
a housing comprising recessed openings defining the plurality of selectable input zones,
wherein the housing supports stabilization behavior including climbing, gripping, leaning, or perching while remaining responsive to communicative input.

13. The system of claim 1, further comprising:
non-illuminated static identifiers associated with the selectable input zones,
wherein the non-illuminated static identifiers comprise printed cards, engraved symbols, tactile textures, or passive displays configured to avoid flicker detectable relative to a critical flicker fusion threshold of a target animal species.

14. The system of claim 1, wherein each selectable input zone is activated by an activation force less than 50 grams.

15. The system of claim 1, wherein each selectable input zone permits surface deformation within a range of 1-3 mm.

16. The system of claim 1, wherein the one or more sensors are configured to detect contact through a non-conductive, deformable protective overlay positioned to reduce exposure to moisture, saliva, or particulate contamination while permitting detection of contact forces within a range of 10-50 grams.

17. A method for controlling an animal assistive communication system, comprising:
mechanically activating one or more selectable input zones using deformable contact surfaces configured for activation by animal appendages;
detecting contact events independently at each of the one or more selectable input zones;
measuring contact duration for each selectable input zone using independent timers;
determining contact events occurring within a first predetermined duration interval as intentional communicative input;
determining contact events exceeding a second predetermined duration interval as stabilization behavior; and
detecting communicative input at a first selectable input zone while sustained stabilization contact is maintained at a second selectable input zone without suppressing responsiveness.

18. The method of claim 17, wherein detecting contact events comprises detecting the contact events using one or more of capacitive sensors, force-sensitive resistors, thin-film pressure sensors, piezoelectric sensors, membrane switches, or combinations thereof.

19. The method of claim 17, wherein the first and second predetermined duration intervals are configurable based on anatomical characteristics of a target animal species.

20. The method of claim 17, wherein the deformable contact surfaces are mechanically compliant contact surfaces that are activated by an activation force smaller than an activation force required to activate human-oriented input devices.
